(19) United States
(12) Patent Application Publication
(10) Pub. No.: US 2008/0148298 A1
(43) Pub. Date: Jun. 19, 2008

(54) System and Methods for Providing Granular Security for Locally Running Scripted Environments and Web Applications

(75) Inventors: Manjirnath Chatterjee, San Francisco, CA (US); Gregory R. Simon, San Francisco, CA (US)

Correspondence Address: KACVINSKY LLC;C/O INTELLEVATE, P.O. BOX 52050, MINNEAPOLIS, MN, 55402, US

(73) Assignee: PALM, INC., Sunnyvale, CA (US)

(21) Appl. No.: 12/019,362

(22) Filed: Jan. 24, 2008

Related U.S. Application Data
(63) Continuation-in-part of application No. 11/612,282, filed on Dec. 18, 2006.
(60) Provisional application No. 60/886,297, filed on Jan. 24, 2007.

(51) Int. Cl. G06F 9/54

(52) U.S. Cl. 719/328

(57) ABSTRACT

Various embodiments are described for an application runtime environment that provides secure safe access to local resources from web based applications when applications are locally hosted or cached or when a safe broker is needed to ensure that a trusted program is given access to specific functionality. The application runtime environment allows enhanced scripting interfaces and locally running web service interfaces to provide individual function level security controls which restrict access to only those applications which are signed. The application runtime environment provides finer granularity and control at the function level by allowing scripted runtime based applications to call local functions in a signed manner with function call level control. Other embodiments are described and claimed.

### RELATED APPLICATIONS

This application claims priority to U.S. Provisional Patent Application Ser. No. 60/886,297, which was filed on Jan. 24, 2007. This application is also related and claims priority to U.S. patent application Ser. No. 11/612,282 titled “System for Running Web Applications Offline and Providing Access to Native Services,” which was filed on Dec. 18, 2006. These applications are entirely incorporated by reference.

### BACKGROUND

In pure web browser based applications, which are commonly used on the Internet, the use of scripting languages to create experiences with automatic data updates without the need for reloading pages has become common. Examples of this are news and sports pages where a user “surfs” to a website by typing in a web address in a browser and then the site loads pages which the user can read.

Recently it has become common for these pages written in a combination of HTML/XHTML, JavaScript/ECMAScript, and CSS or Macromedia® Flash® web page authoring languages to update themselves without a page reload. For example, a user may surf to a site such as a sports page containing the scores for that day. The page loads and shows the current scores. A script starts running which periodically (e.g., every 2 minutes) updates the scores shown without reloading the page.

This method reduces bandwidth since only the score information needs to be updated periodically and is commonly called “Ajax” in the web industry. This is short for Asynchronous JavaScript with XML, but the key idea is that web pages can contain small programs written in a scripting languages to update data without an entire page reload.

While these programming technologies showcase the power of web based software, there are still limitations. In particular, web based software cannot easily access local resources such as the filesystem or custom functionality such as phonebooks or attached hardware. This is due to security concerns that users could surf to a website and then inadvertently have their computer damaged or information stolen or manipulated by unscrupulous web sites.

Accordingly, there exists the need for a system and methods for providing improved security for locally running scripted environments and web based applications.

### BRIEF DESCRIPTION OF THE DRAWINGS

FIG. 1 illustrates one embodiment of a scripted security system.

FIG. 2 illustrates one embodiment of a computing device.

FIG. 3 illustrates one embodiment of a computing device.

FIG. 4 illustrates one embodiment of a communications system,

FIG. 5 illustrates one embodiment of a logic flow.

FIG. 6 illustrates one embodiment of a logic flow.

FIG. 7 illustrates one embodiment of a logic flow.

FIG. 8 illustrates one embodiment of a computing device.

FIG. 9 illustrates one embodiment of a browser view.

FIG. 10 illustrates one embodiment of a logic flow.

### DETAILED DESCRIPTION

Various embodiments are directed to an application runtime environment for providing scripted runtime security and for allowing standalone applications to be authored for desktop computers and mobile device using scripting applications which have high portability among different operating systems. The application runtime environment supports automated security policies and installation processes for web technology based applications. In addition, these application runtime environments separate the executable code from the native environment such as when a scripting language runs in a browser or via an interpreted language such as Java or BASIC.

The application runtime environment provides secure, safe access to local resources from web based applications when applications are locally hosted or cached or when a safe broker is needed to ensure that a trusted program is given access to specific functionality. Mobile devices and desktop computer environments provide browsers with scripting interfaces or on-device Simple Object Access Protocol (SOAP) services which can access information with is normally sandboxed. The application runtime environment allows enhanced scripting interfaces and locally running web service interfaces to provide individual function level security controls which restrict access to only those applications which are signed.

The application runtime environment provides finer granularity and control at the function level rather then forcing an all or nothing approach to control over an application where the application either runs completely unfettered or is completely blocked from running. In particular, the application runtime environment allows scripted runtime based applications to call local functions in a signed manner with function call level control.

With respect to web archives, the collection of web assets for a web application may be treated as a single file which can be signed and distributed in a secure fashion. A signing file may be automatically generated when bundling the web archive to provide details as to the APIs (e.g. SOAP calls) an application uses at signing when the application is registered with the certifying authority.

When provided with a list of native functions to be used by an application, both the signing authority and the system where the application is eventually installed can compare functions that the application attempts to use against the list of functions which were signed and authorized. This provides an extra layer of security for the target operating system and implementation of system wide security policies to determine whether to allow an application to be installed and whether the functions that an application uses violate such policies.

The decision to execute a function call may be delegated in real-time to the operating system so that overall security is consistent with the blanket security policies of the operating system. By giving responsibility for allowing function calls to the operating system, platform level security control at the API level may be implemented across multiple runtime environments and requiring the runtime environments to only track which application is requesting what service. Accordingly, the operating system may maintain control of security and access for scripted applications and minimize the amount of security authority that must be deferred to the various application runtime environments.

The application runtime environment also may couple the signing process and installation of virtual machine or scripted runtime layer based applications back to core operating system in a unified way. In particular, the operating system may be involved in the accepting of signed scripted or bytecode based applications when granting permission to install an application.

In addition, by using IP address and port address combinations, multiple separate web application running on the same local computing device may be tracked and kept separate. Accordingly, different security levels may be enforced among multiple applications running on the same device and application integrity may be persevered even if one of the applications is a “rogue” application.

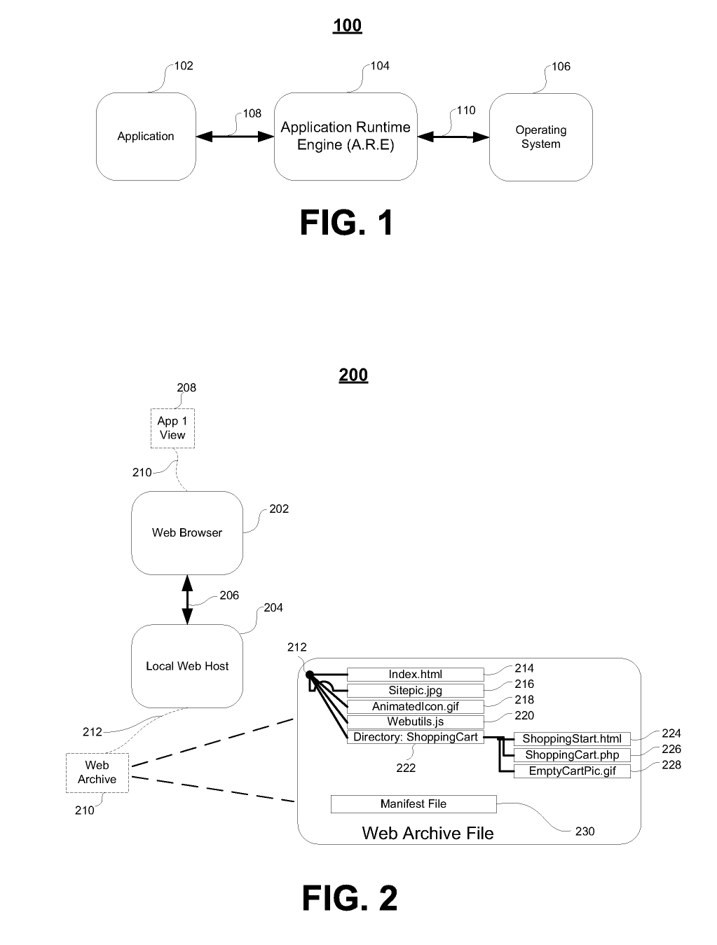

FIG. 1 illustrates a scripted runtime security system 100 suitable for implementing various embodiments. Elements of the system 100 may comprise various physical and/or logical components for communicating information which may be implemented as hardware components (e.g., computing devices, processors, logic devices), executable computer program instructions (e.g., firmware, software) to be executed by various hardware components, or any combination thereof, as desired for a given set of design parameters or performance constraints. Although FIG. 1 may show a limited number of components by way of example, it can be appreciated that a greater or a fewer number of components may be employed for a given implementation.

In various embodiments, the scripted runtime security system 100 may comprise or be implemented as a computing device such as personal computer (PC), desktop PC, notebook PC, laptop computer, mobile computing device, smart phone, personal digital assistant (PDA), mobile telephone, combination mobile telephone/PDA, video device, television (TV) device, digital TV (DTV) device, high-definition TV (HDTV) device, media player device, gaming device, messaging device, or any other suitable communications device in accordance with the described embodiments.

The computing device comprising the scripted runtime security system 100 may form part of a wired communications system, a wireless communications system, or a combination of both. For example, the computing device may be arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The computing device may be arranged to communicate information over one or more types of wireless communication links. Examples of a wireless communication link may include, without limitation, a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. In wireless implementations, the computing device may comprise one more interfaces and/or components for wireless communication such as one or more transmitters, receivers, transceivers, amplifiers, filters, control logic, wireless network interface cards (WNICs), antennas, and so forth. Although certain embodiments may be illustrated using a particular communications media by way of example, it may be appreciated that the principles and techniques discussed herein may be implemented using various communication media and accompanying technology.

As shown in FIG. 1, the scripted runtime security system 100 may comprise an application 102, an Application Runtime Environment (A.R.E.) 104, and an operating system (OS) 106. Examples of suitable applications and environments for implementing aspects of the described embodiments may include Basic, Java, and browser based applications running scripting languages such as JavaScript, ECMAScript, VBScript, Adobe Macromedia Flash, Java, or any scripted programming language where browser based scripts, bytecode sets, or language is interpreted in real time by runtime interpreter.

The A.R.E. 104 may comprise or be implemented as an application runtime engine, runtime interpreter, runtime parser, runtime arbiter, virtual machine (VM), scripting engine, or other suitable runtime environment in accordance with the described embodiments. The OS 106 may comprise or be implemented by a Microsoft® OS, Unix® OS, Linux® OS, Palm OS®, Symbian OS™, Embedix OS, Binary Run-time Environment for Wireless (BREW) OS, JavaOS, a Wireless Application Protocol (WAP) OS, or other suitable OS in accordance with the described embodiments.

In various implementations, the application 102 may comprise a scripted application running on top of the A.R.E. 104. To access operating system controlled functionality such as the file system, networking, or local software or hardware services, the application 102 makes special function calls to the A.R.E. 104. For example, when the application 102 wishes to execute a native function it places a library call through the A.R.E. 104 to the OS 106. The application 102 and the A.R.E. 104 may communicate via path 108 representing the stack connection between application statements and the runtime parser of the A.R.E. 104. The A.R.E. 104 may act on behalf of the application 102 and communicate the call to the OS 106 via path 110.

In some embodiments, the A.R.E. 104 may receive an individual function call from a browser based application 102 running locally on a computing device. The A.R.E. 104 may check the individual function call against a signed list of allowed function calls to restrict access to protected native functions and data of the computing device. In some cases, the function call may request access to functionality controller by the OS 106 such as access to a local file system, a local database, a local software service, a local hardware service, and/or any other controlled resource in accordance with the described embodiments.

In some implementations, the A.R.E. 104 may be responsible for determining whether to block or allow the function call. In such implementations, the decision to block or allow the function call may be made by the A.R.E. 104 after comparing the individual function call to the list of allowed functions calls. In some cases, the A.R.E. 104 may access a manifest file comprising the signed list of allowed function calls and a digital signature. The A.R.E. 104 may verify the digital signature with a certifying authority.

In some cases, the A.R.E. 104 may block or allow the individual function call according to an operating system security policy. For example, the A.R.E. 104 may send the OS 106 a manifest file including a list of native functions to be used by the application 102 at the time the application 102 is to be installed. If the OS 106 disallows certain functions, the A.R.E. 104 may cache the functions which are not permitted. In the event that the A.R.E. 104 subsequently receives a function call from the application 102 for a disallowed function, the A.R.E 104 may block the function call based on the security policy of the OS 106 without having to contact the OS 106.

If the OS 106 allows installation and accepts all the functions, the A.R.E. 104 may cache the list of functions permitted by the OS 106. When the A.R.E. 104 subsequently receives a function call from the application 102 for an allowed function, the A.R.E 104 may send the function call to the OS 106 for execution without having to verify the function call with the OS 106. In some cases, the A.R.E. 104 may attach a digital signature to the OS 106 when a function call is executed.

In some embodiments, the A.R.E. 104 may delegate the responsibility for function level execution decisions to the OS 106. In response to receiving a function call, the A.R.E. 104 may check to see if the function should be executed, append an application ID or signature to the function parameters, and pass the function call and parameters to the OS 106. The OS 106 then makes the ultimate decision whether to execute or block the function call.

While certain examples have been described, it can be appreciated that various types of enforcement mechanisms and runtime policy decisions may be implemented by the A.R.E. 104 and/or the OS 106 in accordance with the described embodiments.

FIG. 2 illustrates one embodiment of a computing device 200 suitable for implementing various scripted runtime security measures. As shown, the computing device 200 may comprise a browser 202 connected to a local web host 204 via an http connection 206. In operation, a web application (e.g., application 102) may be run in the browser 202 of the computing device 200, and the local web host 204 may comprise a runtime interpreter (e.g., A.R.E. 104) in accordance with the described embodiments.

In this embodiment, the browser 202 may display a view 208 to the user as a functional user interface. The view 208 may be connected to the browser 202 via a path 210 which may be implemented by a tab displayed by the browser 202. The local web host 204 may comprise or be implemented as a local http server and proxy logic running locally on the same computing device 200 (e.g., PC or mobile telephone) running the browser 202. When implemented as a server-on-client, the local web host 204 may support multiple web applications running on the computing device 200, low latency as content is local, access to local device services such as camera media stores or phonebooks, and ease of authoring as the same paradigm used to author large web sites can be used to author portable client side applications. For example, the local web host 204 may provide access to local resources of the computing device 200 via web methods programming interfaces such as SOAP or XML calls.

As shown, the local web host 204 may serve a web application (e.g., application 102) out of a web archive 210 accessed via connection 212. In various embodiments, the local web host 204 may be implemented as a Web Virtual Machine, and the web archive 210 may be generated as described in U.S. patent application Ser. No. 11/612,282 titled “System for Running Web Applications Offline and Providing Access to Native Services,” which was filed on Dec. 18, 2006 and is entirely incorporated by reference.

The web archive 210 may comprise a collection of the necessary application files for a web application (e.g., application 102). The web archive file 210 may comprise a bundle or package of the web assets of the web application. Exemplary web assets may include index files, HTML files, script files (e.g., JavaScript or server script such as PHP, Python or Perl), graphics (e.g., JPEGs, GIFs), animations, directories, and other web application components. The packing, storage, and compression of the web archive 210 can be accomplished using standard file archiving libraries such as zip, gzip or zlib, or other suitable packing schemes. When packaged, the directory structure of a web application which would normally be splayed out over a directory tree is aggregated and compressed into a single web archive 210 which allows the web application to be a treated as a single file, signed, and distributed in a secure fashion.

An expanded view of an exemplary web archive 210 is illustrated in FIG. 2. As shown the web archive 210 includes a node representing a root directory 212 where the application is stored and an index file 214 (Index.html) representing a default page to return in response to a request from the web browser 202. After loading the index file 214, other items in the root directory 212 may be presented such as items 216 (Sitepic.jpg), 218 (AnimatedIcon.gif), and 220 (Webutils.js), which in this case are graphics and a JavaScript file to add interactivity.

The root directory 212 also includes item 222 (Directory: ShoppingCart), which is a directory containing more assets of the website and application resources including items 224 (ShoppingStart.html), 226 (ShoppingCart.php), and 228 (EmptyCartPic.gif) representing web assets that can be invoked through a direct path request (e.g., www.example.com/ShoppingCart/ShoppingStart.html), perhaps in response to following a hyperlink on the original web page. It is noted that plug-in languages may be used to redirect the index file 214 to other local assets and/or to launch a login script to ask the user to login for accessing privileged content and that some script files such as item 226 (ShoppingCart.php) may invoke programs to store user data in a database.

In addition to the web assets of the web application, the web archive 210 also comprises a packing or manifest file 230. The manifest file 230 may be implemented as name-value pairs, as an XML format, or any other format which can contain readable metadata. The manifest file 230 may contain metadata for the web applications such as application name information, checksum information (including information for each file in the archive or for the whole archive), digital signature information about the application, and information about the application's runtime needs and required APIs.

In various embodiments, the manifest file 230 contains digital signature information about the web application (e.g., application 102) and lists each specific native function that the application stored in the web archive file 210 will execute. The manifest file 230 may bind the digital signature to the list of native functions to be executed by the application when it was signed. The manifest file 230 may be automatically generated when bundling the web archive 210 to provide details as to the APIs (e.g. SOAP calls) an application uses at signing when the application is registered with the certifying authority.

By accessing and examining the manifest file 230, a system may compare its signature with a list of functions the application is allowed to run. The digital signature may be verified online with a certifying authority to verify the signature and confirm that the there has been no modification to the application since the time of signing. If the signature matches that of a certifying authority, the application may be allowed to run and access native services knowing not only that the application comes from a trusted source but also what system resources in specific that this particular application consumes. In general, only those resources listed in the signed manifest file 230 are allowed to be accessed. If other resources are requested, an alert can be created, and the application signature can be reported to a security authority for nonconformance.

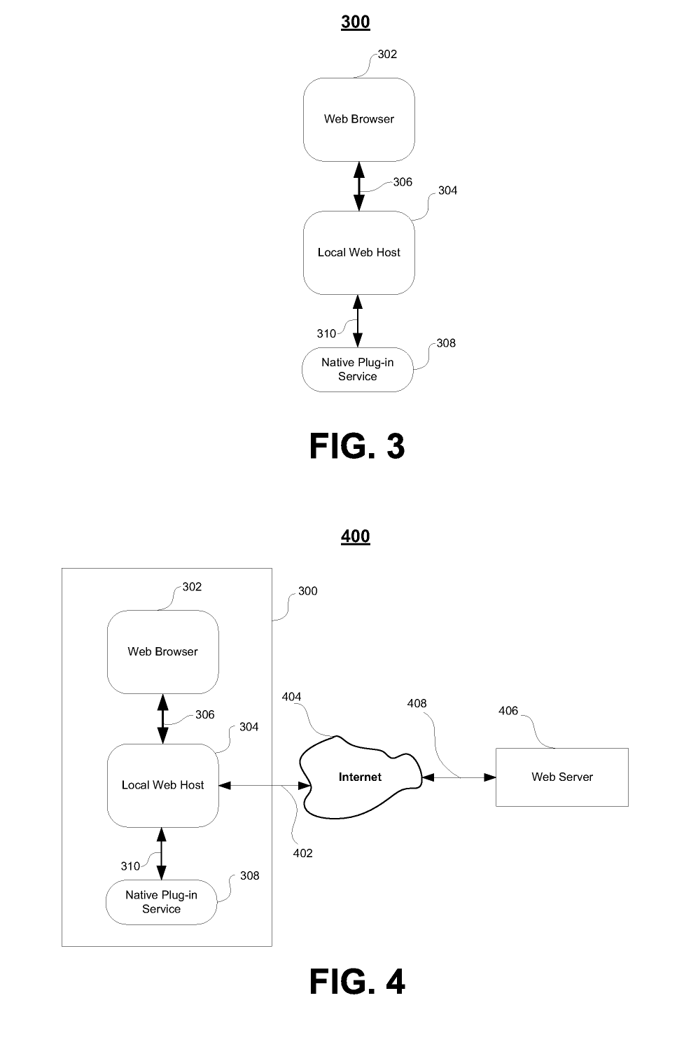

FIG. 3 illustrates one embodiment of a computing device 300 suitable for implementing various scripted runtime security measures. As shown, the computing device 300 may comprise a browser 302 connected to a local web host 304 via an http connection 306. In operation, a web application (e.g., application 102) may be run in the browser 302 of the computing device 300, and the local web host 304 may comprise a runtime interpreter (e.g., A.R.E. 104) in accordance with the described embodiments.

In this embodiment, the local web server 304 may extend web services calls to an application programming interfaces (API) of the local environment. The local web host 304 may be implemented by a server placed on the same computing device 300 as the browser 302 such that an internet connection is not required. Since the local web host 304 and the browser 302 both are located on the computing device 300, it is possible for a browser based application (e.g., application 102) to use web services programming methods to access native functionality of the computing device 300 via a plug-in service 308. The plug-in service 308 may be implemented as an extension API which permits local services to expose functionality to the web programming environment. The local services may be accessed via a path 310 implemented by any suitable programmatic means such as C++ programming interfaces, database calls, and the like.

The local web server 304 may broker local services and may emulate an entire server side web services stack with web services extensions via SOAP, XML RPC, REST or the like to allow the web programming model to access a local file system, database, or even device specific proprietary interfaces such as a camera in the case of a wireless phone. The local web server 304 may leverage the ability to run server side code such as PHP, Python, PERL or CGI programming environments locally, on the computing device 300, as part of the deployed application environment. Accordingly, the local web server 304 may allow the use of server side programming techniques to be combined with client side web technologies through the use of SOAP services, XML RPC services and the like to access local resources while still preserving the enforcement of web based security models and access restrictions in accordance with the described embodiments.

FIG. 4 illustrates one embodiment of a communications system 400 suitable for implementing various scripted runtime security measures. As shown, the communications system 400 may include a computing device 300 comprising a browser 302 connected to a local web host 304 via an http connection 306. In operation, a web application (e.g., application 102) may be run in the browser 302 of the computing device 300, and the local web host 304 may comprise an runtime interpreter (e.g., A.R.E. 104) in accordance with the described embodiments.

The local web host 304 may access native functionality of the computing device 300 through a plug-in service 308 via a path 310 as described above in FIG. 3. In this embodiment, the local web host 304 also may have an http connection 402 (e.g., ethernet, LAN, broadband or dial up connection) to the Internet 404 and may communicate with an offsite web server 406 connected to the Internet via an http path 408 (e.g., a hosted broadband connection). This allows the local web server 304 to intermediate between Internet based web applications and a locally running web application (e.g., application 102).

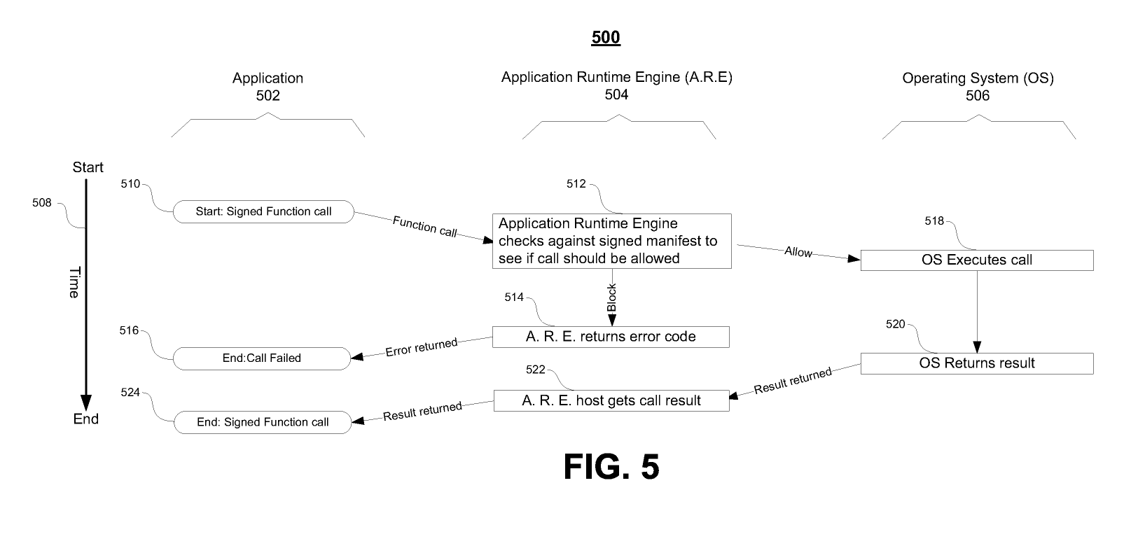

FIG. 5 illustrates one embodiment of a logic flow 500 for deciding whether to execute a function call. The logic flow 500 may be performed by various systems and/or devices and may be implemented as hardware, software, firmware, and/or any combination thereof, as desired for a given set of design parameters or performance constraints. For example, the logic flow 500 may be implemented by executable programming instructions to be executed by a logic device (e.g., computer, processor).

As shown, the logic flow 500 depicts various operations performed by an application 502, an A.R.E. 504, and an OS 506 with respect to a time line 508 with the top being earlier in time and the bottom being later in time. In this embodiment, the A.R.E 504 may be arranged to act as a security deputy responsible for allowing or disallowing a given function call.

In operation, the application 502 sends a signed function call to the A.R.E. 504 to request execution of a native function (box 510). In response to receiving the function call, the A.R.E. 504 makes a decision whether to allow or block the function call (block 512). For example, the A.R.E. 504 may determine whether the particular application 502 is allowed to execute the native function by checking the function call against a signed manifest comprising a list of permitted functions. In some cases, the A.R.E. 504 may verify a digital signature included in the signed manifest with a certifying authority. For instance, the A.R.E. 504 may check online with the certifying authority and may either adopt or reject the response the response of the signing authority.

If the A.R.E. 504 decides not to execute the function, the A.R.E. 504 forms an error code such as a privilege violation error for return to the application 502 (box 514). If blocked, the function call is not sent to the OS 506, and an error is returned because the function will fail. When the error is returned to the application 502 indicating the failure of the function, the application 502 can decide how to handle the error (box 516). For example, in some cases, the application 502 may display a dialog box informing the user that the function is disallowed and requesting user input. In other cases, the application 502 may terminate. It can be appreciated that the application 502 may implement various error handling policies in accordance with the described embodiments.

If the function is allowed by the A.R.E. 504, the OS 506 executes the function call (box 518), and the OS gets the result for the function call (box 520). The A.R.E. receives the result of the function call from the OS 506 reformats the result (e.g., translates from native form to scripted language or byte code) for return and use by the application 502 (box 522). The application 502 receives the result from the A.R.E. 504 and may use the returned result of the function call as needed (box 524).

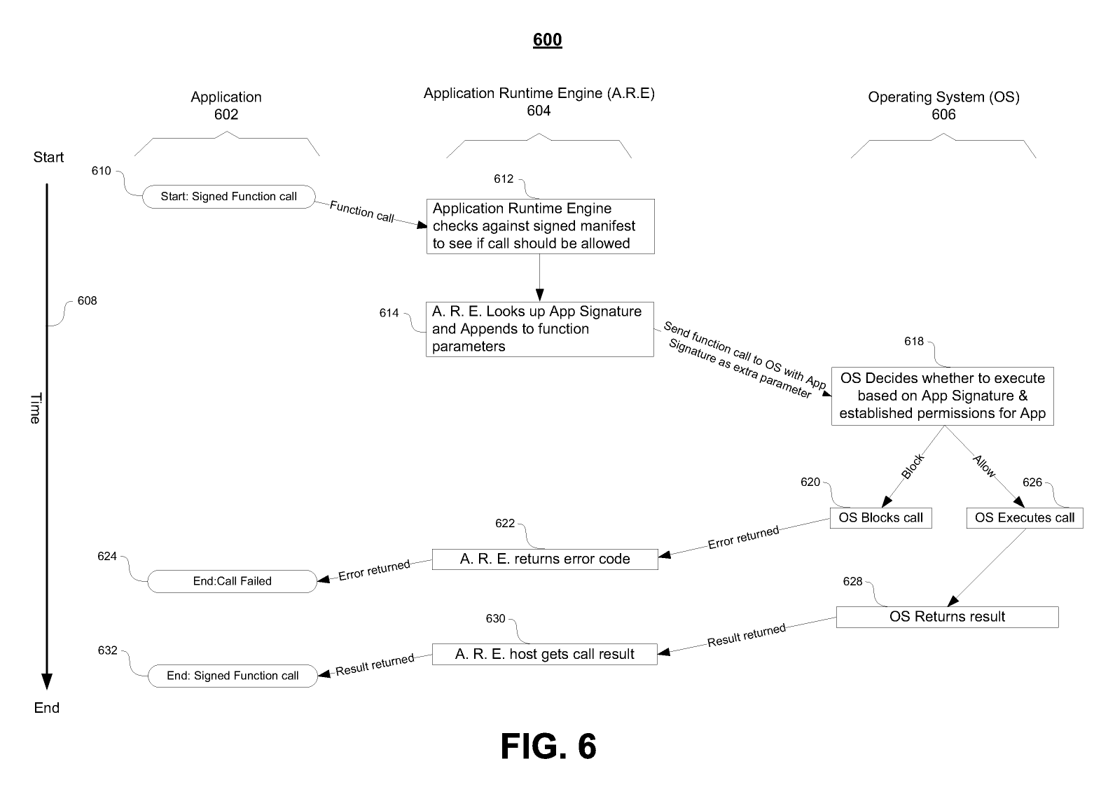

FIG. 6 illustrates one embodiment of a logic flow 600 for deciding whether to execute a function call. The logic flow 600 may be performed by various systems and/or devices and may be implemented as hardware, software, firmware, and/or any combination thereof, as desired for a given set of design parameters or performance constraints. For example, the logic flow 600 may be implemented by executable programming instructions to be executed by a logic device (e.g., computer, processor).

As shown, the logic flow 600 depicts various operations performed by an application 602, an A.R.E. 604, and an OS 606 with respect to a time line 608 with the top being earlier in time and the bottom being later in time. In this embodiment, the A.R.E 604 may be arranged delegate responsibility for allowing or disallowing a given function call to the OS 606.

It can be appreciated that complexity increases with granularity and that as the number of application runtimes increases, it becomes more difficult for the OS 606 to implement system wide security policies. If each application runtime is making a separate security decision, the overall security of a system is only as good as the weakest security policy. For example, if the OS 606 permits a certain runtime environment, a malicious application that is allowed to run using the permitted runtime environment may perform malicious functions despite the security policy of the OS 606.

By delegating the decision of whether to execute native function calls to the OS 606, the OS 606 is responsible for the execution of a given native function call according to its own security policies and avoids confused deputy problems. Because security is handled by the OS 606 rather than the A.R.E. 604, the only task at which the A.R.E. must excel is tracking which application is asking for which function and transmitting the application ID or signature along with the function call as an extra parameter to the OS 606. In effect the A.R.E. 604 informs the OS 606 that the application 602 wishes to execute a particular function call and allows the OS 606 to decide whether the function will be permitted. While performance may degrade if every function call for every application must go through a two proxy mechanism, security may be paramount in some environments. Furthermore, arbitration may be limited to only when accessing a new resource which may be an infrequent occurrence.

In operation, the application 602 sends a signed function call to the A.R.E. 604 to request execution of a native function (box 610). In response to receiving the function call, the A.R.E. 604 checks to see if the function should be executed (box 612). The A.R.E. 604 then looks up the application ID or signature which is appended to the function parameters and passed to the OS 606 in real time (box 614). The OS 606 decides whether to execute the function call based on the application signature and established permissions for the application 602 (box 618).

If the OS 606 does not allow the function to be executed, the OS 606 blocks the functional call and issues an error (box 620). The A.R.E. 604 receives the error from the OS 606 and reformats the error code for return to the application 602 (box 622). The application 602 receives the returned error and can decide how to handle the error (box 624).

If OS 606 allows the function to be executed, the OS executes the function call (box 626). The OS 606 gets and returns the result for the function call to the A.R.E. 604 (box 628). The A.R.E. receives the result of the function call from the OS 606 and reformats the native result for return and use by the application 502 in the application runtime language (box 630). The application 602 receives the result from the A.R.E. 604 and may use the returned result of the function call as needed (box 632).

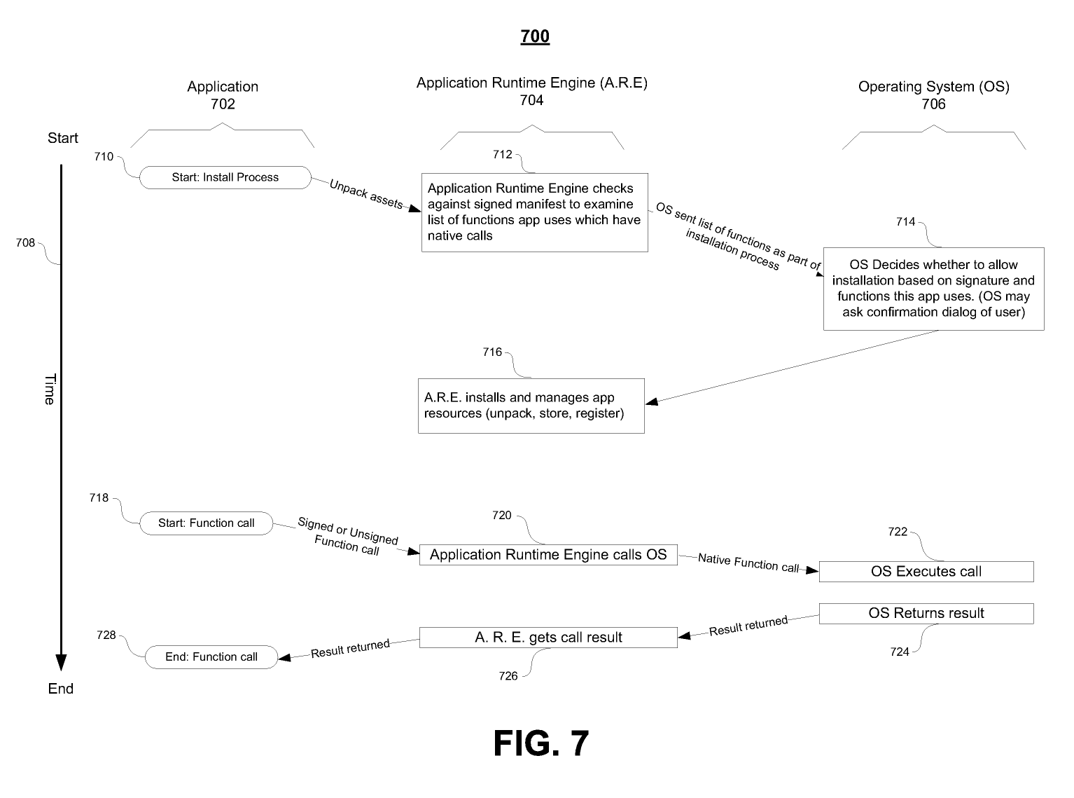

FIG. 7 illustrates one embodiment of a logic flow 700 for deciding whether to execute a function. The logic flow 700 may be performed by various systems and/or devices and may be implemented as hardware, software, firmware, and/or any combination thereof, as desired for a given set of design parameters or performance constraints. For example, the logic flow 700 may be implemented by executable programming instructions to be executed by a logic device (e.g., computer, processor).

As shown, the logic flow 700 depicts various operations performed by an application 702, an A.R.E. 704, and an OS 706 with respect to a time line 708 with the top being earlier in time and the bottom being later in time. In this embodiment, speed may be improved by moving from real time handling of each function call to requesting permission from the OS 706 for all of the functions to be used by the application 702 at the time the application 702 is installed. The A.R.E. 704 acts as an agent on behalf of the OS 706 for packing and unpacking, but the ultimate acceptance of the application 702 is left to the OS 706 such that the OS 706 is always in direct control of security and application installation decisions. Accordingly, the OS 706 can implement system wide security policies for the A.R.E. 704 as well as other application runtimes.

In operation, the application 702 beings installation and unpacks the web assets for the application (box 710). The assets are received by the A.R.E. 704 which then checks the signed manifest to examine the list of functions to be used by the application 702 which have native calls and sends the manifest to the OS 706 for inspection (box 712). The OS 706 receives the manifest and decides whether to allow installation based on the digital signature and list of functions (box 714). In some cases, the OS 706 may present the list of functions to the user in a dialog box requesting user input to allow or block installation.

If installation is allowed and all the functions are accepted, the A.R.E. 704 installs and manages (e.g., unpacks, stores, and registers) the application resources permitting future use of the application (box 716). Otherwise, the A.R.E. 704 will block the disallowed functions and/or prevent the application 702 from being executed in the future.

In this embodiment, the A.R.E. 704 may cache the list of functions permitted by the OS 706 such that the A.R.E. 704 may determine whether to allow or block future function calls based on the security policy of the OS 706 without having to forward the function calls to the OS 706. In some cases, the A.R.E. 704 may periodically synchronize with the OS 706 to confirm that security policy of the OS 706 is current and/or the OS 706 may alert the A.R.E. 704 in the event of a policy change or update.

Subsequently, the application 702 sends a function call to the A.R.E. 704 to request execution of a native function (box 718). This diagram represents either a signed or unsigned call. An example of unsigned call may be a call built in to the language environment such as a call to print text on a screen which is generally built in to the A.R.E. 704 and/or may be an atomic construct of a language (e.g., “println” in Java).

Assuming that the function call is for a function previously permitted by the OS 706, the A.R.E. 704 calls the OS 706 and forwards the native function call to the OS 706 (box 720). The OS 706 executes the function call (box 722), and returns the result (box 724). The A.R.E. 704 receives the result of the function call from the OS 706 reformats the result for return and use by the application 702 (box 726). The application 702 receives the result from the A.R.E. 704 and may use the returned result of the function call as needed (box 728). In general, there is no need to verify each function call with the OS 706 when the application 702 has been prescreened. It can be appreciated, however, that additional security measures such as those described in FIGS. 5 and 6 may be implemented in some embodiments.

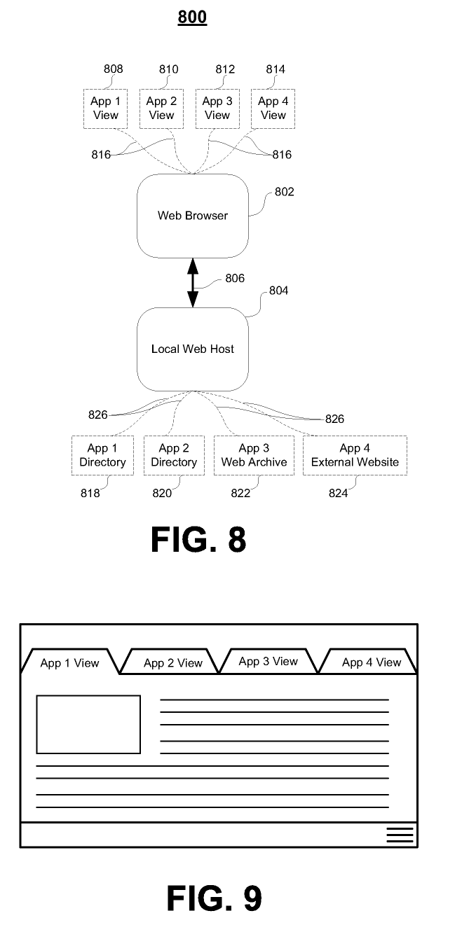

FIG. 8 illustrates a computing device 800 suitable for implementing various embodiments. As shown, the computing device 800 may comprise a browser 802 connected to a local web host 804 via an http connection 806. In this embodiment, the web browser 802 may display views 808, 810, 812, and 814 for multiple applications served simultaneously by the local web host 804 via path 816 which may be implemented as tabs. The local web host 804 serves the multiple applications out of directories 818, 820, a web archive 822 which represents a compacted collection of the necessary application files, and an external website 824.

FIG. 9 represents a web browser depicting multiple applications each running as a separate tab. Visually users of desktop computers are likely to see such a representation when using multiple simultaneous web applications. On a mobile device, a user may be likely to see sequential views.

Existing IP address to IP address session model and cookies (shared among users) bind a computing device to a server. If multiple applications are co-hosted on the same server, such as when if the server is on the same device as the browser such as when running cached web applications locally, then cross site scripting may occur.

When a server is hosting multiple applications on the same computing device that is running the web browser, such as when running cached web applications locally, the applications might be able to see each other's data once a single application is authenticated. It is noted that this is not the case when multiple applications are hosted on separate servers.

After logging in, the user effectively would be authenticated to all the local applications allowing different local applications to see each others files. This can lead to cross site scripting flaws since the applications would not have separation under clean separation. Typical server side languages such as PHP, Python and Perl keep session variables bases on cookies and client side IP address connections. If such languages are used to serve multiple applications on a computing device which is running the browser, the session variables (server side script variables) would be shared among the application thereby losing separation.

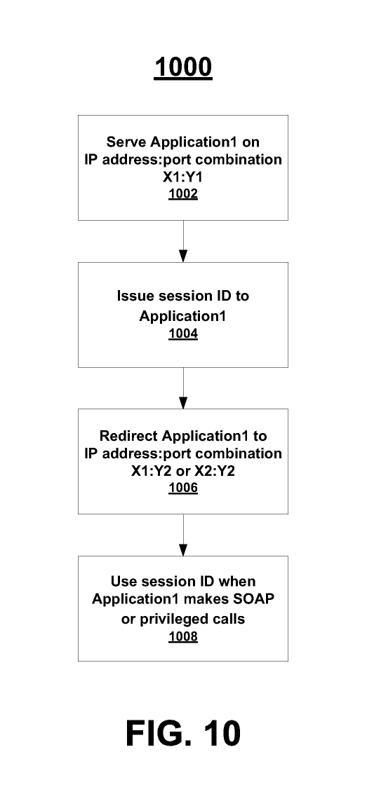

FIG. 10 illustrates one embodiment of a logic flow 1000 for serving multiple web applications. The logic flow 1000 may be performed by various systems and/or devices and may be implemented as hardware, software, firmware, and/or any combination thereof, as desired for a given set of design parameters or performance constraints. For example, the logic flow 1000 may be implemented by executable programming instructions to be executed by a logic device (e.g., computer, processor).

When started, Application1 is served on IP address: port combination X1:Y1 (box 1002) and issued a session ID (box 1004). Application1 is then redirected to X1:Y2 or X2:Y2 (box 1006). It can be appreciated that once Application1 is redirected, the session ID is no longer in the HTTP headers. Consequently, other applications would not be aware of the session ID for Application1. Even if another application is served on the same IP address:port combination (e.g., X1:Y2 or X2:Y2), the other application will not have the session ID for Application1 and will be unable to read the data for Application1. Application1 may use the session ID to make SOAP or privileged calls (box 1008). Since the session ID is generated in real-time, only Application 1 can know what it is.

In general, multiple applications may be served simultaneously when different Internet Protocol addresses:port combinations are used. By using different IP address and port combinations, applications may be treated as separately and tracked. As such, applications with different security levels may be isolated from one another for preventing a rogue application from snooping and keeping application data secure.

It can be appreciated, that some computers can only sustain a limited number of open TCP/IP connections. If each locally running web application is using a different address:port pair, then the number of allowed connections could be exceeded. In various embodiments, multiple applications may start out on a single dedicated IP address:port combination when they are first served and issued an ID in a header. The multiple applications are then redirected or handed off to separate ports or IP address:port combinations where they are run. By starting multiple applications on a single IP address:port combination and then redirecting applications to separate ports, the number of combinations can be lessened to reduce local network strain while still maintaining security among multiple applications.

In various embodiments, rolling codes may be used for session management. For example, a session code may be issued and then rolled every time a call is made. Once the application is started, each page refresh uses a rolling code to encode its response so as to maintain a secure link which is not static between the client and the server. Accordingly, using rolling code may allow page level authentication for web based applications. In some implementations, every time SOAP call is made, the page must roll to the next page number sequence from the original page served header. Since each application instance (not just each user instance) has separated temporary tracking IDs which are attached to SOAP calls, application data access can be limited to only authorized applications. If synchronicity is lost, an application may not be able to recover without getting a new page number code sequence which could necessitate rebooting the application and going back to the initial port to get a new code.

In some cases, multiple applications can be hosted on a single server which resides on the same client by binding an address:port pair to an application signature ID. For example, a path (example: com.google.app1 to a ip_address:port pair) (perhaps in signed bundle) may be matched to port ID for enforcement. The use of address:port combinations and session IDs may be combined in a single access control technique to keep web application data sequestered to only those web applications which own the data. In various embodiments, data can be written to a tagged repository with a key, and later retrieved by another application which matches the key. The keys may be public/private key pairs instead of symmetric keys.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

Although some embodiments may be illustrated and described as comprising exemplary functional components or modules performing various operations, it can be appreciated that such components or modules may be implemented by one or more hardware components, software components, and/or combination thereof.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, or any combination thereof.

In various embodiments, logic flow may comprise, or be implemented as, executable computer program instructions. The executable computer program instructions may be implemented by software, a software module, an application, a program, a subroutine, instructions, an instruction set, computing code, words, values, symbols or combination thereof. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The executable computer program instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Some embodiments may be implemented as an article of manufacture comprising a computer-readable storage medium to store executable computer program instructions for performing various operations as described herein. In such embodiments, a computer may include any suitable computer platform, device, system, or the like implemented using any suitable combination of hardware and/or software.

The article and/or computer-readable storage medium may comprise one or more types of computer-readable storage media capable of storing data, including volatile memory or, non-volatile memory, removable or non-removable memory, erasable or non-erasable memory, writeable or re-writeable memory, and so forth. Examples of computer-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other suitable type of computer-readable storage medium in accordance with the described embodiments.

In various embodiments, a logic flow may comprise, or be implemented as, executable computer program instructions stored in an article of manufacture and/or computer-readable storage medium. The article and/or computer-readable storage medium may store executable computer program instructions that, when executed by a computer, cause the computer to perform methods and/or operations in accordance with the described embodiments. The article and/or computer-readable storage medium may be implemented by various systems and/or devices in accordance with the described embodiments.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, API, exchanging messages, and so forth.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computing device comprising:
an application runtime environment for receiving an individual function call from a browser based application running locally on the computing device and for checking the individual function call against a signed list of allowed function calls to restrict access to protected native functions and data of the computing device.

2. The computing device of claim 1, wherein the application runtime environment comprises a runtime interpreter for interpreting browser based scripts in real time.

3. The computing device of claim 1, the individual function call comprising a request to access functionality controlled by an operating system of the computing device.

4. The computing device of claim 3, the individual function call comprising a request to access at least one of a local file system, a local database, a local software service, and a local hardware service.

5. The computing device of claim 3, the application runtime environment to determine whether to block or allow the function call.

6. The computing device of claim 5, the application runtime environment to block or allow the function call according to an operating system security policy.

7. The computing device of claim 3, the operating system to determine whether to block or allow the function call.

8. The computing device of claim 1, the application runtime environment to access a manifest file comprising the signed list of allowed function calls and a digital signature.

9. The computing device of claim 8, the application runtime environment to verify the digital signature with a certifying authority.

10. The computing device of claim 8, the application runtime environment to pass the function call and the digital signature to the operating system.

11. The computing device of claim 1, wherein application runtime environment is implemented by a local web host.

12. The computing device of claim 3, wherein the local web host comprises a web services stack.

13. A method comprising:
receiving an individual function call from a browser based application running locally on a computing device; and
checking the individual function call against a signed list of allowed function calls to restrict access to protected native functions and data of the computing device.

14. The method of claim 13, comprising blocking or allowing the function call according to an operating system security policy.

15. The method of claim 13, comprising delegating a decision to block or allow the function call to an operating system.

16. The method of claim 15, comprising passing a digital signature associated with the application to the operating system.

17. A method for delegating native function calls from an application runtime environment to an operating system in real-time comprising:
sending an application script code to the operating system; and
receiving permission from the operating system to execute one or more native function calls based on the application script code.

18. The method of claim 17, wherein said application script code comprises a manifest file including a list of native level functions used by a scripted application.

19. The method of claim 18, where the application runtime environment sends the manifest file to the operating system at time of installation to seek permission to install the scripted application.

20. The method of claim 18, comprising presenting the list of native functions used by the scripted application to a user for inspection.

21. The method of claim 20, comprising receiving user input to block installation after inspection.

22. The method of claim 17, comprising attaching a digital signature to the operating system when a native function is executed.

23. A method for serving multiple web applications comprising:
running multiple web applications locally on a single computing device; and
serving the multiple web applications simultaneously using different address and port combinations.

24. The method of claim 23, wherein the multiple applications have different permission levels.

25. The method of claim 23, comprising:
serving the multiple applications on a single address and port combination; and
redirected the multiple applications to separate address and port combinations.

26. The method of clam 23, comprising:
serving a first application on a first address and port combination; and
redirecting the first application to a second port address combination.

27. The method of claim 26, comprising:
issuing a session identifier to the first application; and
uses the session identifier to make a Simple Object Access Protocol call or privileged call from the first application.

28. The method of claim 23, wherein once a particular application is started, each page refresh uses a rolling code to encode a response for maintaining a secure link that is not static between a web server and a client.

29. The method of claim 23, comprising:
writing data to a tagged repository with a key; and
retrieving the data by another application matching the key.

30. The method of claim 29, wherein the key comprises public/private key pairs.
